(19) United States
(12) Patent Application Publication
(10) Pub. No.: US 2015/0352899 A1
(43) Pub. Date: Dec. 10, 2015

(54) Friction Wheel for a Shopping Cart

(71) Applicant: Technibilt, Ltd., Newton, NC (US)

(72) Inventors: Francois Morin, Montreal (CA); Gennaro Rosato, Montreal (CA); Rene Hebert, St-Sauveur (CA); William E. Kiser, III, Lincolnton, NC (US); Michael DeVillier, Newton, NC (US)

(21) Appl. No.: 14/735,609

(22) Filed: Jun. 10, 2015

Related U.S. Application Data
(60) Provisional application No. 62/010,155, filed on Jun. 10, 2014.

(51) Int. Cl. B60B 33/00; B62B 5/04

(52) U.S. Cl. CPC B60B 33/0028; B62B 5/048; B60B 33/0039

(57) ABSTRACT

A friction wheel includes a ring and bearing assembly, the friction ring extending from opposite sides of the bearing and having an inner facing surface; a hub surrounding an inner passage sized for receipt of the ring and bearing assembly, and the hub including an annular lip extending therefrom on opposite sides of the hub; at least one cap having an annular rim sized and configured for secured attachment to the annular lip, and each cap including an annular sleeve extending therefrom, and wherein the ring is sized for engaged receipt of the annular sleeve; raised elements on the annular sleeve sized and configured for a friction fit against the inner facing surface of the ring; and wherein relative rotation between the at least one cap and the ring requires a force sufficient to overcome the friction fit between the raised elements and the inner facing surface of the ring.

### RELATED APPLICATION

This application is a Non-provisional Patent Application relating to and claiming the benefit of U.S. Provisional Patent Application Ser. No. 62/010,155 filed on Jun. 10 2014.

### FIELD OF THE INVENTION

This invention relates to shopping carts and, more particularly, to a wheel device provided for limiting movement of a shopping cart on a surface decline.

### BACKGROUND OF THE INVENTION

Shopping carts are traditionally used by customers for transporting goods during shopping from the shelves to the checkout counter and then to the customer's vehicle in an adjacent parking lot for loading of the purchased goods therein. Shopping carts typically include two or more swivel wheels mounted thereon for transporting the cart. These shopping carts are often left unattended in the parking lot with the intent that store personnel retrieve them intermittently. Shopping cart corrals are provided in the parking lot so that customers can place their empty carts therein after the goods have been unloaded from the carts into their vehicles. However, it has been found that in many instances the shopper does not place the cart in the cart corral, but simply leaves it in the parking lot near where his or her vehicle was parked. When the carts are left unattended in the parking lot, particularly when left outside the corral, there is a possibility that a force exerted onto it, such as wind, will cause the cart to aimlessly roil. Perhaps more frequently, the cart might roll away if it was left unattended on a ground surface having a declined slope.

With the foregoing reasons in mind, there exists a need for a shopping cart wheel that limits the likelihood that a shopping cart will roll away when left unattended.

Moreover, the shopping cart wheel should still permit selective movement operation of the shopping cart by a user. Similarly, there exists a need to prevent shopping carts from rolling away during loading or unloading of the goods. It is particularly desirable that such a shopping cart wheel would prevent an empty shopping cart from roiling away when on a 2-degree slope.

### SUMMARY OF THE INVENTION

In accordance with one form of the present invention, there is provided a wheel including a ring and bearing assembly, the friction ring extending from opposite sides of the bearing and having a cylindrical inner facing surface; a hub surrounding an inner passage sized for receipt of the ring and bearing assembly, and the hub including an annular lip extending therefrom on opposite sides of the hub; at least one cap having an annular rim sized and configured for secured attachment to the annular lip on the hub, and the at least one cap including an annular sleeve extending from an inner facing surface of the cap, and wherein the opposite sides of the ring are sized and configured for engaged receipt of the annular sleeve; at least one raised element on an outer surface of the annular sleeve, the at least one raised element being sized and configured for a friction fit against the cylindrical inner facing surface of the ring; and wherein relative rotation between the at least one cap and the ring requires a force sufficient to overcome the friction fit between the at least one raised element and the cylindrical inner facing surface of the ring.

In accordance with another form of the present invention, there is provided a shopping cart including a basket; at least one mounting bracket and axle assembly secured to the basket; and at least one wheel including a ring and bearing assembly, the friction ring extending from opposite sides of the bearing and having a cylindrical inner facing surface; a hub surrounding an inner passage sized for receipt of the ring and bearing assembly, and the hub including an annular lip extending therefrom on opposite sides of the hub; at least one cap having an annular rim sized and configured for secured attachment to the annular lip on the hub, and the at least one cap including an annular sleeve extending from an inner facing surface of the cap, and wherein the opposite sides of the ring are sized and configured for engaged receipt of the annular sleeve; at least one raised element on an outer surface of the annular sleeve, the at least one raised element being sized and configured for a friction fit against the cylindrical inner facing surface of the ring; and wherein relative rotation between the at least one cap and the ring requires a force sufficient to overcome the friction fit between the at least one raised element and the cylindrical inner facing surface of the ring.

### BRIEF DESCRIPTION OF THE DRAWINGS

For a fuller understanding of the nature of the present invention, reference should be made to the following detailed description, taken in conjunction with the accompanying drawings in which:

FIG. 1 is an exploded view of the friction wheel device of the present invention in accordance with one embodiment;

FIG. 2 is a perspective view of the friction cap in accordance with one embodiment;

FIG. 3 is a perspective view, shown in partial cross-section, of the friction wheel device of the present invention and showing a first friction cap apart from the wheel and a second friction cap secured thereto;

FIG. 4 is a perspective view of the friction wheel device of he present invention;

FIG. 5 is a side elevational view of the friction wheel device of the present invention;

FIG. 6 is an exploded view of the friction wheel device of the present invention in accordance with a further embodiment;

FIG. 7 is a perspective view of a shopping cart having first and second friction wheel devices on the rear side of the shopping cart; and

FIG. 8 is a perspective view of a shopping cart having first and second ion wheel devices on the front side of the shopping cart.

Like reference numerals refer to like parts throughout the several views of the drawings.

### DETAILED DESCRIPTION OF THE PREFERRED EMBODIMENTS

Referring to the several views of the drawings, the friction wheel device of the present invention is shown and is generally indicated as 10. In one embodiment, one or more friction wheels 10 are used in conjunction with a shopping cart 100.

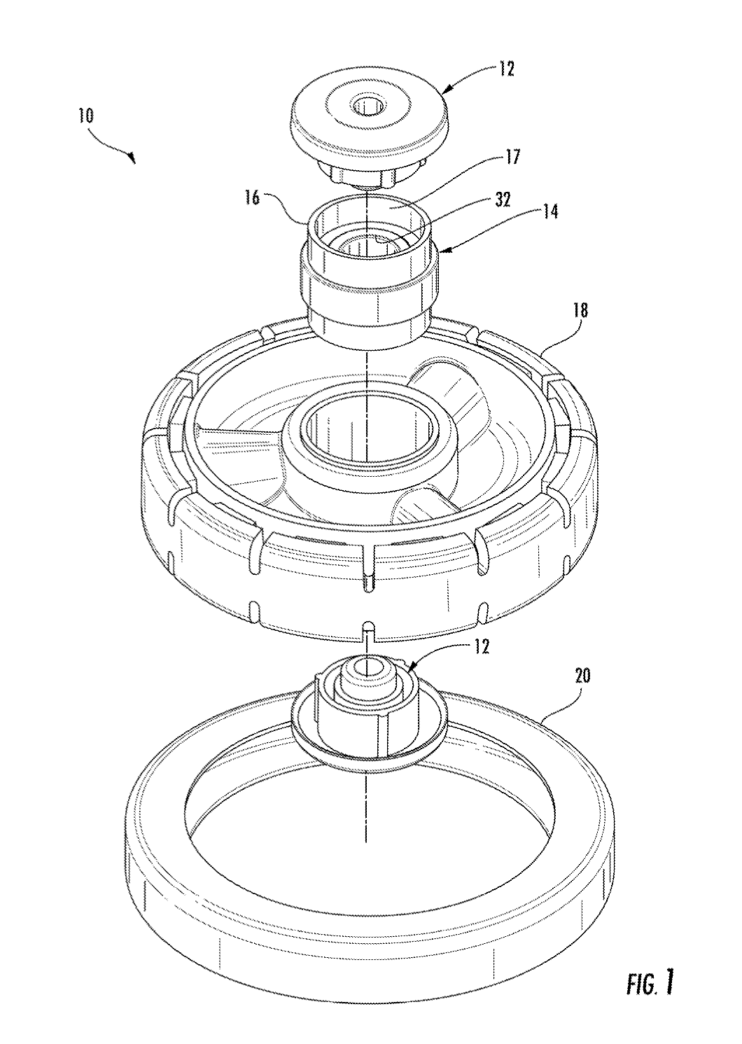

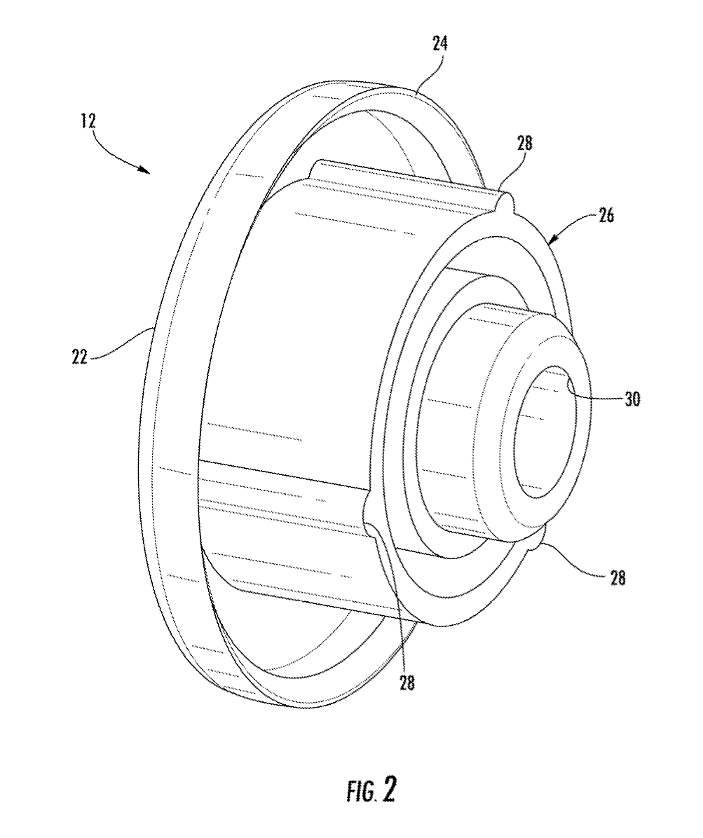

Referring to FIGS. 1 and 2, a friction wheel 10 includes one or more friction caps 12, a bearing 14, a friction ring 16, a hub 18 and a tire 20. The friction cap 12 includes sealing top 22 with an annular rim 24. An annular sleeve 26 extends from the inner facing surface of the sealing top 22 and includes one or more raised friction elements 28 on the outer surface of the annular sleeve 26. An axle passage 30 extends the length of friction cap 12.

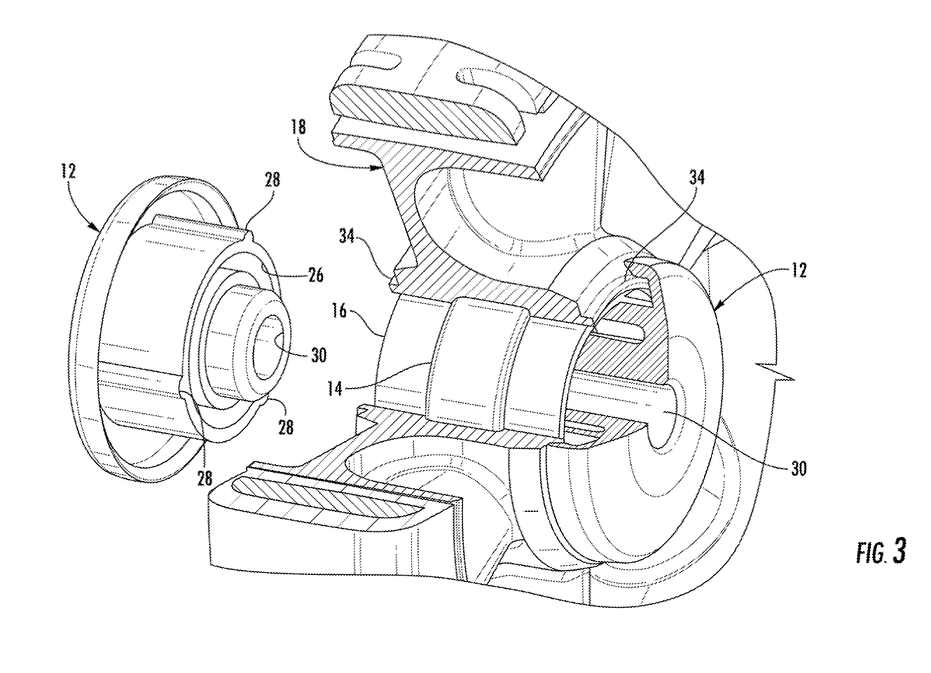

Referring to FIG. 3, the annular rim 24 on the friction cap 12 sized for engaged receipt of annular lip 34 on hub 18. Each of the one or more raised friction elements 28 extending outwards from annular sleeve 26 are slightly oversized in relation to the circumference of inner facing surface 17 (see FIG. 1) of friction ring 16, thereby forming a friction fit therebetween. In a preferred embodiment, the raised friction elements 28 are sized and configured to form a friction fit against the inner surface 17 of friction ring 16 that can be overcome by selective force applied by a user on shopping cart 100. In operation, the user pushes shopping cart 100 with force sufficient to overcome the friction fit between the one or more raised friction elements 28 and the inner facing surface 17 of the friction ring 16 to permit relative rotation between the annular sleeve 26 and friction ring 16, thereby moving shopping cart 100.

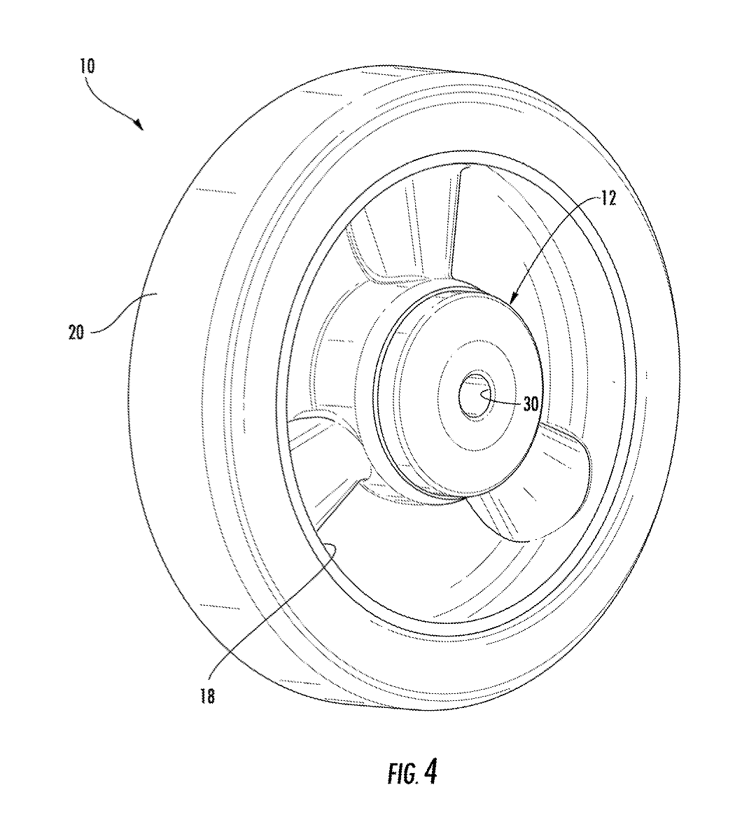

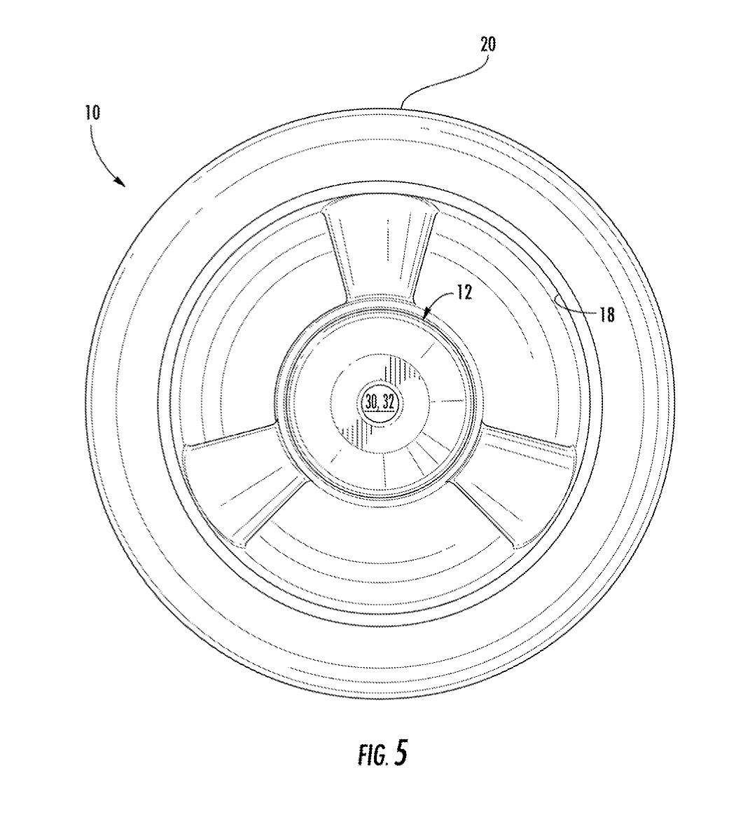

Referring to FIGS. 4 and 5, a fully assembled friction wheel 10 is shown in accordance with one embodiment. Axle passage 30 on friction cap 12 and axle passage 32 (see FIG. 1) on bearing 14 are sized and configured for receipt of an axle therethrough.

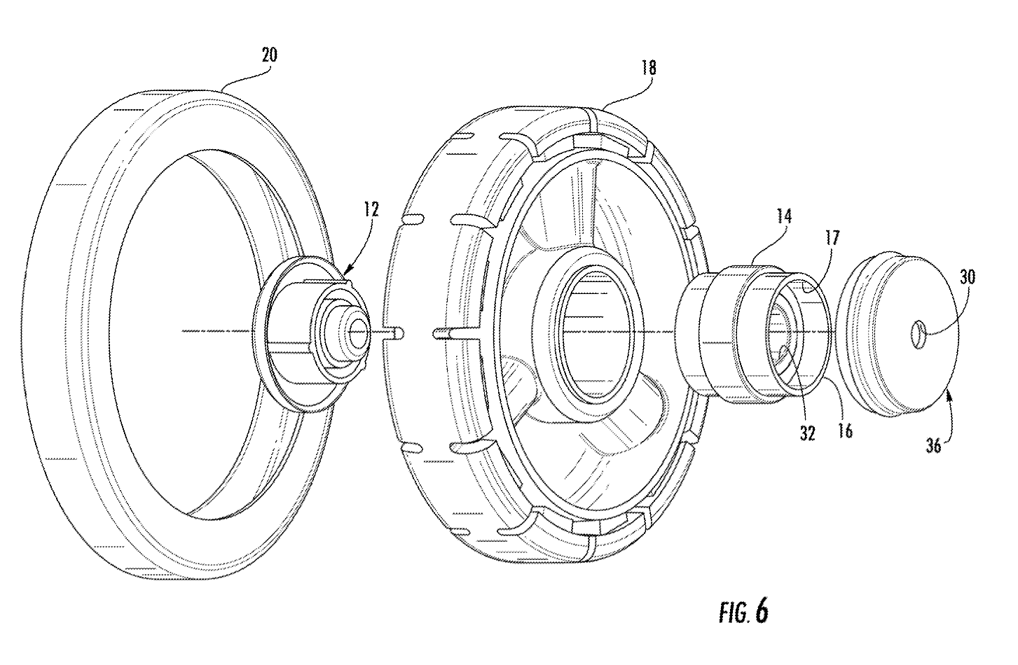

Referring to FIG. 6, another embodiment of friction wheel 10 includes one friction cap 12 on one side of hub 18 and one standard dust cap 36 on the opposite side of hub 18. This embodiment of the friction wheel 10 may include a friction cap 12 on either the inner or outer side of the hub 18 and the dust cap 36 on the opposite side. The dust cap 36 includes a sealing top with an annular rim as is included on friction cap 16. This embodiment produces less friction between the friction cap 12 and friction ring 16 as compared to the embodiment illustrated in FIG. 1 since there are fewer points of interference, i.e., fewer raised friction elements 28 in contact with the friction ring 16.

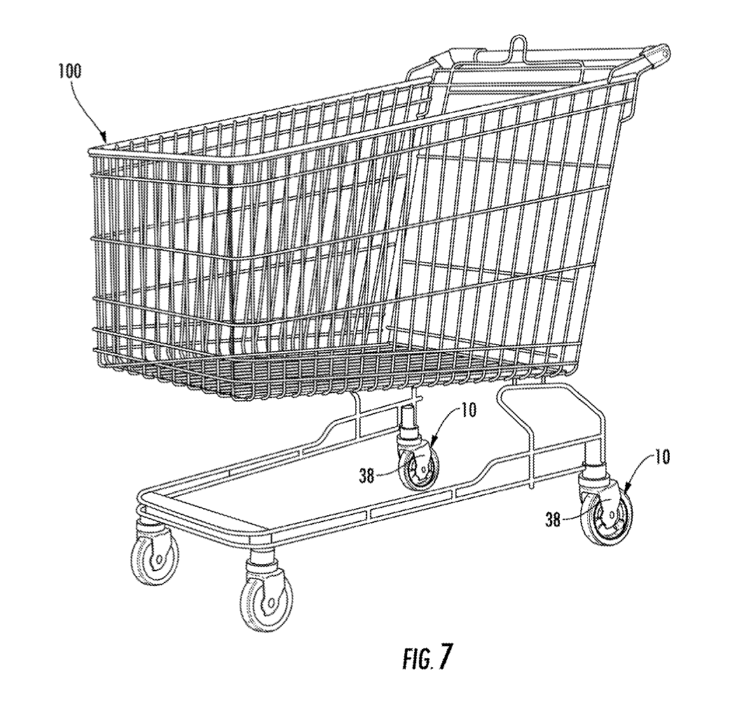

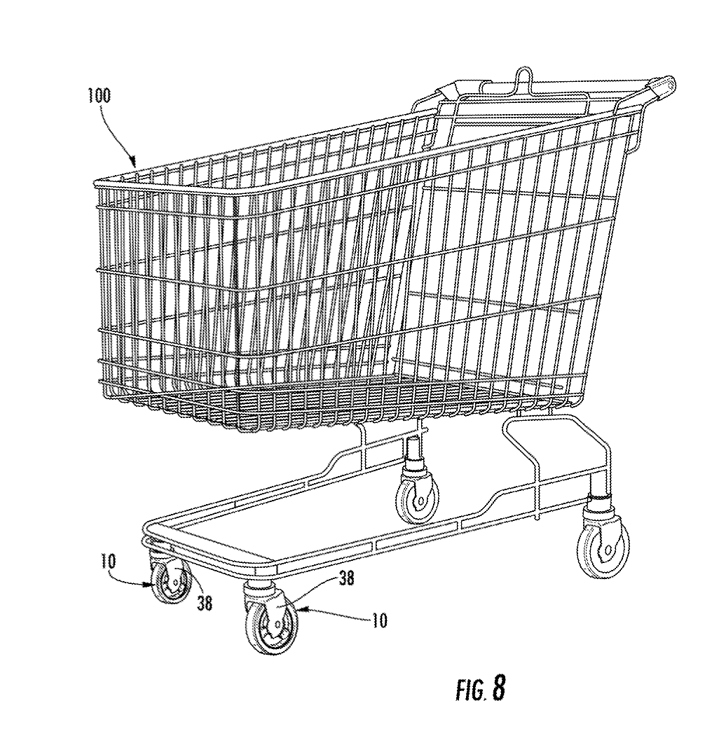

Referring to FIGS. 7 and 8, the friction wheels 10 are shown in conjunction with shopping cart 100. Mounting bracket and axle assemblies 38 secure the friction wheels 10 to the shopping cart 100. The embodiment of the shopping cart 100 shown in FIG. 7 includes first and second friction wheels 10 secured to respective mounting bracket and axle assemblies 38 on the rear side of the shopping cart 100. Standard wheels are on the side opposite the friction wheels. The embodiment of the shopping cart 100 shown in FIG. 8 includes first and second friction wheels 10 secured to respective mounting bracket and axle assemblies 38 on the front side of the shopping cart 100. While not illustrated, a shopping cart 100 could include more than two, e.g., four, friction wheels 10 and respective mounting bracket and axle assemblies 38.

Materials used to form the bearing 14 and friction ring 16 may be selected from materials traditionally used to form standard bearings, such as steel. The hub 18 is preferably formed from a semi-rigid material, such as nylon. The friction cap 12 may be formed from a variety of semi-rigid materials, such as, but not limited to, high density polyethylene.

While the present invention has been shown and described in accordance with several preferred and practical embodiments, it is recognized that departures from the instant disclosure are contemplated within the spirit and scope of the present invention which are not limited except as defined in the following claims as interpreted by the Doctrine of Equivalents.

What is claimed is:

1. A wheel comprising:
a ring and bearing assembly, said ring extending from opposite sides of said bearing and having a cylindrical inner facing surface;
a hub surrounding an inner passage sized for receipt of said ring and bearing assembly, and said hub including an annular lip extending therefrom on opposite sides of said hub;
at least one cap having an annular rim that is sized and configured for secured attachment to the annular lip on said hub, and said at least one cap including an annular sleeve extending from an inner facing surface of said cap, and wherein the opposite sides of said ring are sized and configured for engaged receipt of said annular sleeve;
at least one raised element on an outer surface of said annular sleeve, said at least one raised element being sized and configured for a friction fit against the cylindrical inner facing surface of said ring; and
wherein relative rotation between said at least one cap and said ring requires a force sufficient to overcome the friction fit between said at least one raised element and the cylindrical inner facing surface of said ring.

2. The wheel as recited in claim 1 further comprising at least one tire that is sized and configured for being secured to said hub.

3. The wheel as recited in claim 1 wherein said at least one cap includes a first cap secured to one side of said hub and a second cap secured to the opposite side of said hub.

4. The wheel as recited in claim 1 further comprising a dust cap having an annular rim that is sized and configured for secured attachment to the annular lip on said hub.

5. The wheel as recited in claim 4 wherein one of said at least one caps is secured to one side of said hub and said dust cap is secured to the opposite side of said hub.

6. The wheel as recited in claim 1 wherein said at east one raised element is a first, second and third raised elements.

7. A shopping cart comprising:
a basket;
at least one mounting bracket and axle assembly secured to said basket; and
at least one wheel, and said at least one wheel comprising:
a ring and bearing assembly, said ring extending from opposite sides of said bearing and having a cylindrical inner facing surface;
a hub surrounding an inner passage sized for receipt of said ring and bearing assembly, and said hub including an annular lip extending therefrom on opposite sides of said hub;
at least one cap having an annular rim that is sized and configured for secured attachment to the annular lip on said hub, and said at least one cap including an annular sleeve extending from an inner facing surface of said cap, and wherein the opposite sides of said ring are sized and configured for engaged receipt of said annular sleeve;
at least one raised element on an outer surface of said annular sleeve, said at least one raised element being sized and configured for a friction fit against the cylindrical inner facing surface of said ring; and
wherein relative rotation between said at least one cap and said ring requires a force sufficient to overcome the friction fit between aid at least one raised element and the cylindrical inner facing surface of said ring.

8. The shopping cart as recited in claim 7 wherein a first and a second of said at least one wheels e secured to the rear side of the shopping cart.

9. The shopping cart as recited in claim 7 wherein a first and a second of said at least one wheels are secured to the front side of the shopping cart.

10. The wheel as recited in claim 7 further comprising at least one tire that is sized and configured for being secured to said hub on each of said at least one wheels.

11. The wheel as recited in claim 7 wherein said at least one cap includes a first cap secured to one side of said hub and a second cap secured to the opposite side of said hub.

12. The wheel as recited in claim 7 further comprising a dust cap having an annular rim that is sized and configured for secured attachment to the annular lip on said hub.

13. The wheel as recited in claim 12 wherein one of said at least one caps is secured to one side of said hub and said dust cap is secured to the opposite side of said hub.

14. The wheel as recited in claim 7 wherein said at least one raised element is a first, second and third raised elements.
